(19) United States
(12) Patent Application Publication
(10) Pub. No.: US 2011/0099721 A1
(43) Pub. Date: May 5, 2011

(54) WEIGHT EFFICIENT FLUIDIZED PERSON-SUPPORT APPARATUS

(76) Inventor: Charles A. Howell, Batesville, IN (US)

(21) Appl. No.: 12/609,806

(22) Filed: Oct. 30, 2009

(51) Int. Cl. A61G 7/057; A61G 7/05

(52) U.S. Cl. 5/689

(57) ABSTRACT

A fluidized person-support apparatus comprises a container, a fluidizable medium, and a volume occupier. The container is supported on a frame. The container includes a base and a plurality of sides coupled to the base. The base cooperates with the sides to define a chamber with an opening opposite the base. The fluidizable medium is positioned within the container. The volume occupier is buoyantly suspended in the fluidizable medium.

### BACKGROUND OF THE DISCLOSURE

This disclosure relates generally to fluidized person-support apparatuses. More particularly, but not exclusively, one illustrative embodiment relates to a weight efficient fluidized person-support apparatus.

Some people can be required to remain on person-support apparatuses for extended periods of time. In some instances, pressure on tissues that interface with the person-support apparatus can be comparably higher at or near protuberances of the surface of the body, such as, for example, the heels, the buttocks, and the head. The high interface pressures can increase the probability that pressure sores or decubitus ulcers will develop over time. Fluidized person-support apparatuses can be used to help reduce the interface pressures by fluidizing granular medium to buoyantly suspend a person supported thereon, thereby increasing the surface area being supported and helping distribute the interface pressure points substantially uniformly there along. The volume of the fluidizable medium in the tank is generally greater the volume needed to suspend the person, which can cause the fluidized person-support apparatus to weigh more than non-fluidizable person-support apparatuses. While various fluidized person-support apparatuses have been developed, there is still room for improvement. Thus a need persists for further contributions in this area of technology.

### SUMMARY OF THE DISCLOSURE

The present disclosure includes one or more of the features recited in the appended claims and/or the following features which, alone or in any combination, may comprise patentable subject matter.

One illustrative embodiment of the present disclosure can include a fluidized person-support apparatus with a container containing a fluidizable medium and a plurality of volume occupiers suspended in the fluidizable medium.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a perspective side view of a fluidized person-support apparatus according to an illustrative embodiment;

FIG. 2 is a perspective side view of the fluidized person-support apparatus according to another illustrative embodiment;

FIG. 3 is a cross-sectional end view of the tank of the person-support apparatus along lines Y1-Y1 of FIG. 2 showing the volume occupiers coupled to a screen within the container;

FIG. 4 is a side cross-sectional view of the tank of the person-support apparatus along lines X1-X1 of FIG. 2 showing a plurality of volume occupiers suspended in the fluidizable medium; and

FIG. 5 is a side perspective view of the volume occupiers coupled to a frame according to another illustrative embodiment.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

One illustrative embodiment of the present disclosure can include a fluidized person-support apparatus with a container containing a fluidizable medium and a plurality of volume occupiers suspended in the fluidizable medium.

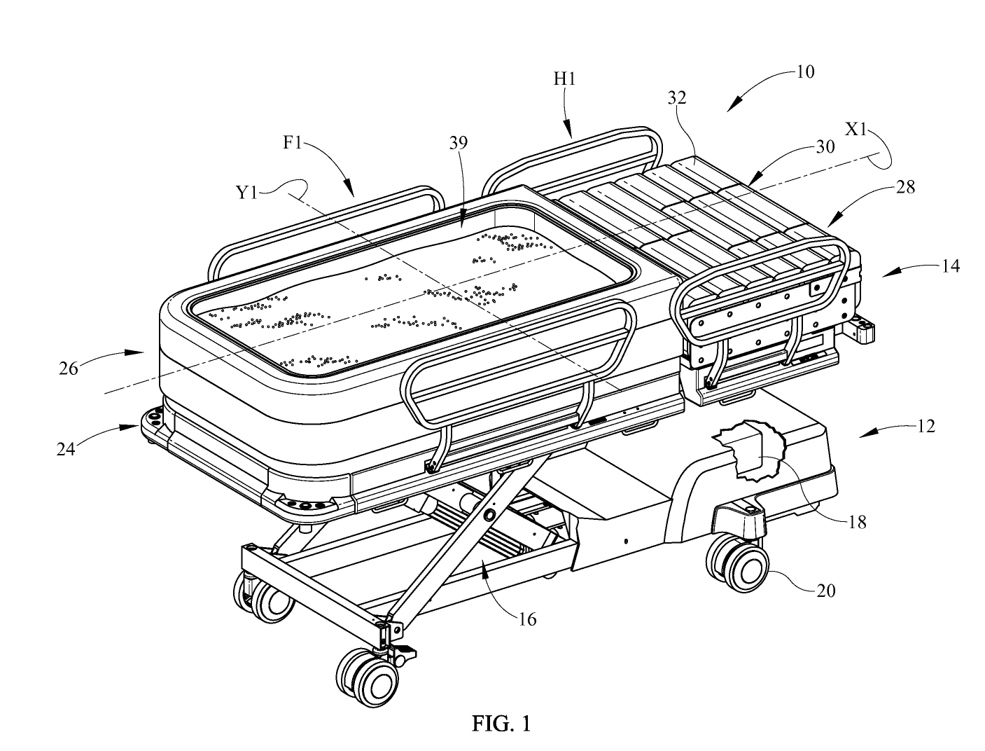

A person-support apparatus 10 according to one illustrative embodiment of the current disclosure is shown in FIGS. 1-5. The person-support apparatus 10 can be a fluidized hospital bed and can include a head section H1, where the head of a person (not shown) is positioned, and a foot section F1, where the feet of a person (not shown) are positioned. The person-support apparatus 10 can include a lower frame 12, an upper frame 14, a plurality of supports 16 supporting the upper frame 14 on the lower frame 12, and a gas supply unit 18. The lower frame 12 can be supported on casters 20 and can be coupled with the supports 16 to support the supports 16 and the upper frame 14.

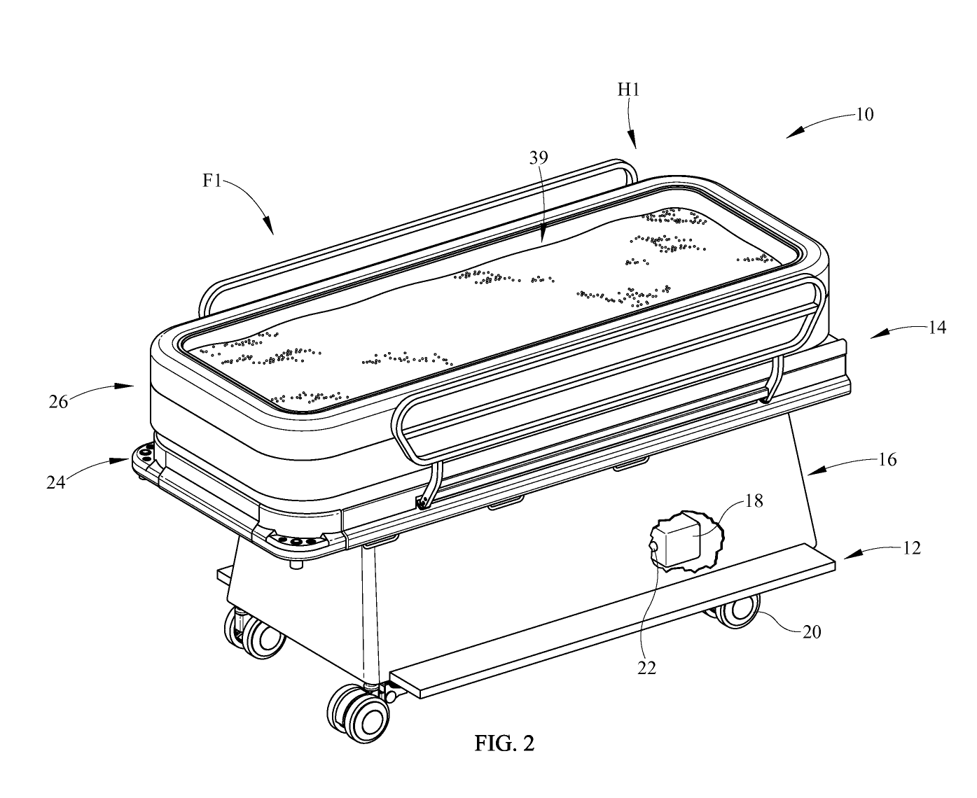

In one illustrative embodiment, the supports 16 can be coupled with the lower frame 12 and the upper frame 14 and can movably support the upper frame 14 above the lower frame 12 as shown in FIG. 1. The supports 16 can be lift mechanisms 16 with a lift driver (not shown) that can cause the lift mechanisms 16 to expand and/or contract to raise and/or lower the upper frame 14 with respect to the lower frame 12. In another illustrative embodiment, the supports 16 can fixedly support the upper frame 14 above the lower frame 12 as shown in FIG. 2.

The gas supply 18 can be integrated into the lower frame 12 and can be configured to supply the gas to the upper frame 14 as shown in FIGS. 1 & 2. It should be appreciated that the gas supply 18 can be removably coupled with or integrated into the upper frame 14 and/or the supports 16. It should also be appreciated that the gas can be remotely supplied, such as, by a head wall unit (not shown). In one illustrative embodiment, the gas supply 18 can be an air blower assembly 18. It should be appreciated that the gas supply 18 can vary the rate at which gas is supplied, as well as the temperature of the gas being supplied. The gas supply unit 18 can be connected to the upper frame 14 through at least one hose 22.

The upper frame 14 can define a longitudinal axis X1 that can extend at least the length of the person-support apparatus 10 through the head end H1 and the foot end F1 along the lateral center of the upper frame 14, and a lateral axis Y1 that can be perpendicular to the longitudinal axis X1 and can extend at least the width of the person-support apparatus 10 through the longitudinal center of the upper frame 14 as shown in FIGS. 1 & 2. It should be appreciated that the head end H1 can be movably coupled to the foot end F1 such that the head end H1 can move with respect to the foot end F1.

In one illustrative embodiment, the upper frame 14 can include an upper frame weldment 24 that can support a tank assembly 26 or container 26 and a head end support assembly 28 as shown in FIG. 1. It should be appreciated that the head end support assembly 28 can articulate with the head end H1 of the upper frame 14 respect to the tank assembly 26. It should also be appreciated that the head end support assembly 28 can be a person-support surface 30 or mattress 30 composed of foam (not shown) and/or having support assembly gas bladders 32. In another illustrative embodiment, the upper frame 14 can include an upper frame weldment 24 that supports a tank assembly 26 as shown in FIG. 2. The head end support assembly 28 of the upper frame 14 can be configured to support a portion of a person's head and/or torso while the tank assembly 26 can be configured to support the pelvic region and lower extremities of a person.

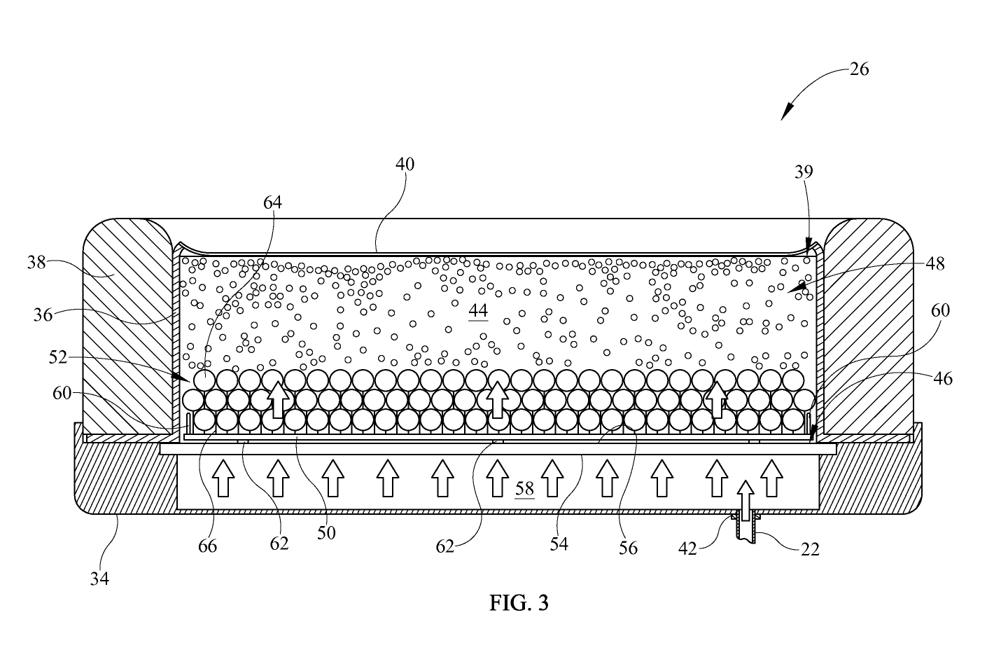

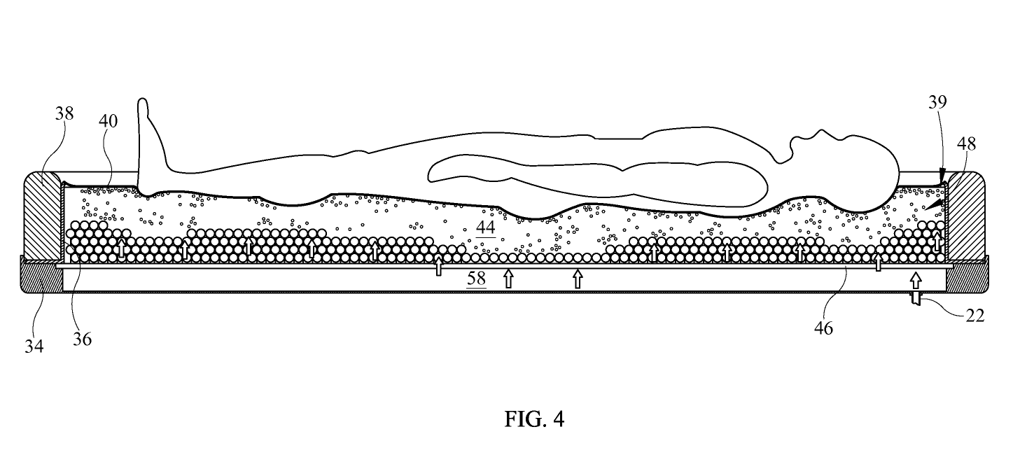

The tank assembly 26 can include a tank base 34, a tank liner 36, a tank bladder 38, and a filter cover 40 or gas permeable cover 40 as shown in FIGS. 3-4. In one illustrative embodiment, the tank base 34 and the tank liner 36 can be made of a low or substantially no air-loss material, such as, for example, a polyurethane-backed nylon fabric material, and the tank bladder 38 can be composed of a substantially no air loss polymeric material and filled with a gas, such as, air. The tank base 34 can be coupled to the upper frame weldment 24 by tank fasteners (not shown) and can include an inlet 42 that can couple with the hose 22. The tank liner 36 and the tank bladder 38 can be coupled together to form the sides of the tank assembly 26. The tank base 34 can be coupled with the tank liner 36 and the tank bladder 38 to define an opening 39 opposite the tank base 34.

The filter cover 40 can be positioned over the opening 39 and can be couple to the tank liner 36 with a cover fastener (not shown) as shown in FIGS. 3-4. It should be appreciated that the cover fasteners can be zippers, buttons, snaps, turn-buttons, hook and loop fasteners, or other fasteners. The tank base 34, the tank liner 36, the tank bladder 38, and the filter cover 40 can cooperate to define a chamber 44 therebetween.

The chamber 44 can contain a diffuser 46 or gas permeable support 46, a fluidizable medium 48, a screen 50, and volume occupier 52 therein as shown in FIGS. 3-4. The diffuser 46 can be a porous board that can be permeable to the gas supplied by the gas supply 18, but not permeable to the fluidizable medium 48. The diffuser 46 can be positioned proximate the tank base 34 and can include a first side 54 and a second side 56. The first side 54 of the diffuser 46 can cooperate with tank base 34 to define a plenum 58, and the second side 56 of the diffuser 46 can contact the fluidizable medium 48 and the screen 50 as shown in FIGS. 3-4 & 6-7. The plenum 58 can receive gas from the gas supply 18 through the inlet 42 and can communicate the gas substantially uniformly through the diffuser 46. The gas in the plenum 58 can be pressurized depending on the flow rate from the gas supply 18 and the porosity of the diffuser 46.

The volume between the diffuser 46 and the filter cover 40 can be filled with the fluidizable medium 48 as shown in FIGS. 3-4. In one illustrative embodiment, the fluidizable medium 48 can be spherical silica beads of the type commonly employed in air fluidized bead person-support systems. It should also be appreciated that the fluidizable medium 48 can range in size from about 50 to about 150 microns in diameter, which can depend on the rate at which gas is supplied through the diffuser 46. Similarly, the rate at which gas is supplied through the diffuser 46 can vary as a function of the size of the fluidizable medium 48 and the depth of the fluidizable medium 48, i.e., the distance between the diffuser 46 and the opening 39.

The screen 50 can include a frame with handles 60 and can be secured to the second side 56 of the diffuser 46 with fasteners 62 as shown in FIG. 4. It should be appreciated that the screen 50 can rest on the second side 56 of the diffuser 46 without being secured thereto. The screen 50 can be used to collect and remove contaminated fluidizable medium 48. The fluidizable medium 48 can become contaminated and form clumps when, for example, the fluidizable medium 48 comes into contact with moisture, such as, urine, sweat, and lymph from wounds, etc. The clumps can have a density greater than the surrounding fluidizable medium 48, which can cause them to sink to the bottom of the tank 24. When the fluidizable medium 48 is to be cleaned, for example, before the person-support apparatus 10 is used by a new person, the contaminated fluidizable medium 48 can be separated from the non-contaminated fluidizable medium 48 by lifting the screen 50 out of the tank 24 and subsequently be sterilized.

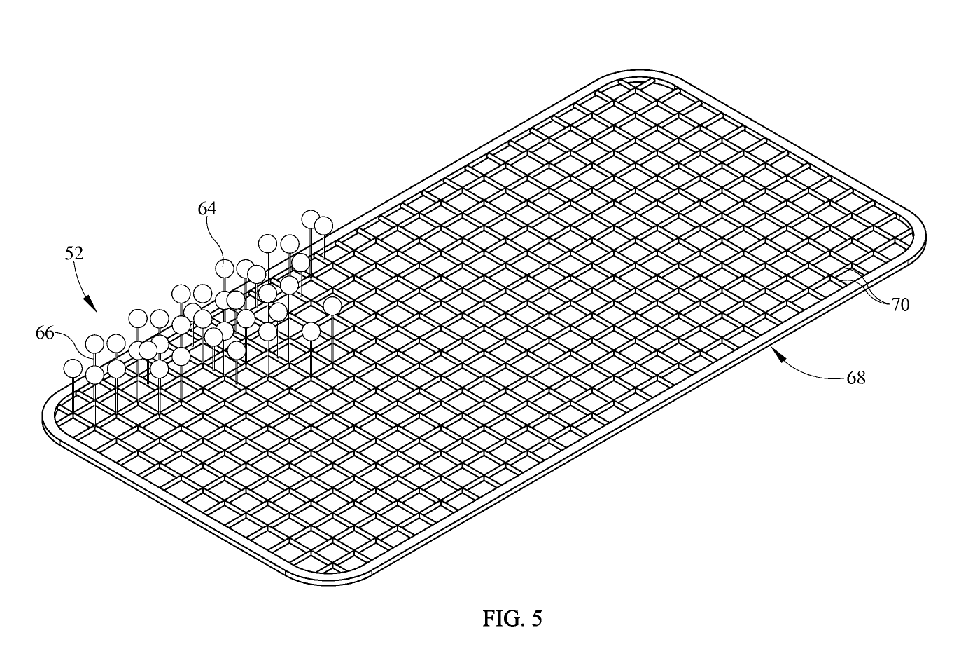

The volume occupier 52 can be positioned between the opening 39 and the diffuser 46 as shown in FIGS. 3-4. The volume occupier 52 can help reduce the weight of the person-support apparatus 10 by reducing the volume of fluidizable medium 46 while maintaining a reduced interface pressure. In one illustrative embodiment, the volume occupier 52 can be an array of tethered spheres 52 that can include a plurality of hollow spheres 64 coupled to the screen 50 by tethers 66. It should be appreciated that the spheres 64 can be other shapes and can be solid or partially hollow. It should also be appreciated that the tether 66 can be a rope, a cord, a cable, a spring, or other tether composed of metal, plastic, or fibrous materials that can be configured to exert at least one of a pulling and pushing force on the volume occupier 52. In another illustrative embodiment, the tethers 66 can couple the volume occupier 52 to the diffuser 46. In still another illustrative embodiment, the tethers 66 can couple the volume occupier 52 to a frame 68 with metal strips 70 that can be positioned on or secured to the screen 50 as shown in FIG. 5. The tethered sphere array 52 can be arranged such that the profile of the array can mimic the profile of a person's body as shown in FIG. 4. The tethered sphere array 52 can be made of any material which has an effective density that is less than the density of the fluidizable medium 48, for example, plastic, foam, and sealed fluid bladders. It should be appreciated that the tethered ball array 52 can be coated with an antimicrobial coating.

In operation, the gas supply 18 can supply a gas to the plenum 58. The gas in the plenum 58 can pressurize and can be communicated substantially uniformly through the diffuser 46. The gas can pass through the diffuser 46 and into the fluidizable medium 48, which can cause the fluidizable medium 48 to move in such a way that the fluidizable medium 48 takes on some fluid-like characteristics and buoyantly suspends the volume occupier 52 therein. Accordingly, the person supported on the filter cover 40 can be buoyantly suspended, which can help distribute the supporting pressure points uniformly along the body surface, i.e., increase the surface area of the body being supported. In cases where a person decreases the surface area being supported, for example, when the person is sitting up or leaning on an elbow, such that the person can contact the diffuser 46, the volume occupier 52 can contact the filter cover 40 and help suspend the person. It should be appreciated that the volume occupier 52 can also help support the weight of a person on the filter cover 40 when the filter cover 40 contacts the volume occupier 52.

Many other embodiments of the present disclosure are also envisioned. For example, a fluidized person-support apparatus, comprises a container, a gas permeable support, a volume occupier, and a tether. The container is supported on a frame. The container includes a base and a plurality of sides coupled to the base. The base cooperates with the sides to define an opening opposite the base. The gas permeable support is positioned within the chamber. The gas permeable support includes a first side and a second side. The first side is spaced apart from the base to define a first chamber and the second side is spaced apart from the opening to define a second chamber. The volume occupier is positioned within the second chamber. The tether is positioned within the second chamber. The tether is configured to couple the volume occupier within the second chamber such that the volume occupier is movable from a first position with respect to the opening to a second position with respect to the opening.

In another example, a fluidized person-support apparatus comprises a container, a fluidizable medium, and a volume occupier. The container is supported on a frame. The container includes a base and a plurality of sides coupled to the base. The base cooperates with the sides to define a chamber with an opening opposite the base. The fluidizable medium is positioned within the container. The volume occupier is buoyantly suspended in the fluidizable medium.

In yet another example, a weight reduction kit for a fluidized person-support apparatus comprises a volume occupier and a tether.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. A fluidized person-support apparatus, comprising:
a container supported on a frame, the container including a base and a plurality of sides coupled to the base, the base cooperating with the sides to define an opening opposite the base;
a gas permeable support positioned within the chamber, the gas permeable support including a first side and a second side, wherein the first side is spaced apart from the base to define a first chamber and the second side is spaced apart from the opening to define a second chamber;
a volume occupier positioned within the second chamber; and
a tether positioned within the second chamber, the tether being configured to couple the volume occupier within the second chamber such that the volume occupier is movable from a first position with respect to the opening to a second position with respect to the opening.

2. The fluidized person-support apparatus of claim 1, wherein the volume occupier is a hollow sphere.

3. The fluidized person-support apparatus of claim 1, wherein the volume occupier has antimicrobial properties.

4. The fluidized person-support apparatus of claim 1, wherein the volume occupiers are maintained below about the opening at a height corresponding to a profile of a person's body.

5. The fluidized person-support apparatus of claim 1, the tether being configured to maintain the volume occupier below about the opening.

6. The fluidized person-support apparatus of claim 5, wherein one end of the tether is coupled to the volume occupier and another end of the tether is coupled to the gas permeable support.

7. The fluidized person-support apparatus of claim 1 further comprising a screen positioned within the second chamber adjacent the second side of the gas permeable support, and a fluidizable medium positioned within the second chamber and contacting the second side of the gas permeable support, the screen being configured to collect contaminated fluidizable medium.

8. The fluidized person-support apparatus of claim 7, wherein one end of the tether is coupled to the volume occupier and another end of the tether is coupled to the screen.

9. The fluidized person-support apparatus of claim 7 further comprising a frame with a plurality of cross members positioned within the second chamber adjacent the screen, one end of the tether being coupled to the volume occupier and another end of the tether being coupled to the frame.

10. The fluidized person-support apparatus of claim 7, wherein the density of the volume occupier is less than the density of the fluidizable medium.

11. A fluidized person-support apparatus, comprising:
a container supported on a frame, the container including a base and a plurality of sides coupled to the base, the base cooperating with the sides to define a chamber with an opening opposite the base;
a fluidizable medium positioned within the container; and
a volume occupier buoyantly suspended in the fluidizable medium.

12. The fluidized person-support apparatus of claim 11, wherein the volume occupier is a hollow sphere.

13. The fluidized person-support apparatus of claim 11, wherein the volume occupier has antimicrobial properties.

14. The fluidized person-support apparatus of claim 11, wherein the volume occupiers are maintained below about the opening at a height corresponding to a profile of a person's body.

15. The fluidized person-support apparatus of claim 11 further comprising a tether configured to couple the volume occupier within the container and maintain the volume occupier below about the opening.

16. The fluidized person-support apparatus of claim 11 further comprising a gas permeable support positioned within the container and spaced apart from the base, a first side of the gas permeable support cooperating with the base of the container to form a first chamber and a second side of the gas permeable support spaced apart from the opening to define a second chamber, the volume occupier and the fluidizable medium being located in the second chamber.

17. The fluidized person-support apparatus of claim 16 further comprising a screen positioned within the second chamber adjacent the second side of the gas permeable support, the screen being configured to collect contaminated fluidizable medium.

18. The fluidized person-support apparatus of claim 17 further comprising a tether, the tether being configured to movably couple the volume occupier to the screen.

19. The fluidized person-support apparatus of claim 17 further comprising a frame with a plurality of cross members positioned within the second chamber adjacent the screen, the volume occupier being movably coupled to the frame with a tether.

20. The fluidized person-support apparatus of claim 11, wherein the density of the volume occupier is less than the density of the fluidizable medium.

21. A weight reduction kit for a fluidized person-support apparatus, comprising:
a volume occupier; and
a tether.

22. The weight reduction kit of claim 21, wherein the volume occupier is a hollow sphere.

23. The weight reduction kit of claim 21, wherein the volume occupier is configured to be positioned within a tank of the fluidized person-support apparatus and buoyantly suspended in a fluidizable medium contained within the tank.

24. The weight reduction kit of claim 23, wherein the volume occupier is less dense than a fluidizable medium contained within the tank.

25. The weight reduction kit of claim 21, wherein the tether is configured to couple to the volume occupier within a tank of the fluidized person-support apparatus and maintain the volume occupier below an opening of the tank.

26. The weight reduction kit of claim 21, wherein the tether is configured to couple to the volume occupier to at least one of a frame, a gas permeable support, and a screen positioned within a tank of the fluidized person-support apparatus.

27. The weight reduction kit of claim 26, wherein one of the frame and the screen is coupled to one of the screen and the gas permeable support, respectively.
